(19) United States
(12) Patent Application Publication
(10) Pub. No.: US 2014/0175958 A1
(43) Pub. Date: Jun. 26, 2014

(54) VENDING MACHINE WITH ROTATABLE DOOR

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YUN-LUNG CHEN, New Taipei (TW); CHUNG CHAI, New Taipei (TW); DA-LONG SUN, Wuhan (CN); LI TONG, Wuhan (CN); GANG CHENG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/043,952

(22) Filed: Oct. 2, 2013

(30) Foreign Application Priority Data
Dec. 21, 2012 (CN) 2012105608813

(51) Int. Cl. G07F 9/10

(52) U.S. Cl. CPC G07F 9/10
USPC 312/35; 312/326

(57) ABSTRACT

A vending machine includes a rack and a door. The rack includes a supporting board. The door is pivotably attached to the rack. The door includes a door panel, a bracket, and a supporting member. The bracket is located on the door panel. The supporting member is mounted to the bracket. The supporting member protrudes from a bottom surface of the door panel. The bottom surface is substantially parallel to the supporting board. When the door is closed relative to the rack, the supporting member abuts the supporting board.

### BACKGROUND

1. Technical Field

The disclosure generally relates to vending machines, and particularly to a vending machine having a rotatable door.

2. Description of Related Art

A vending machine includes a rack for holding goods and a door rotatably attached to the rack by a hinge. The door may be made of metal and has a large thickness for prevention of burglary. However, when the door is closed, the door may hit the rack and damage the rack. Furthermore, a side of the door away from the hinge may drop down after a while. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a vending machine according to one embodiment.

FIG. 2 is an exploded view of a door 30 of the vending machine of FIG. 1.

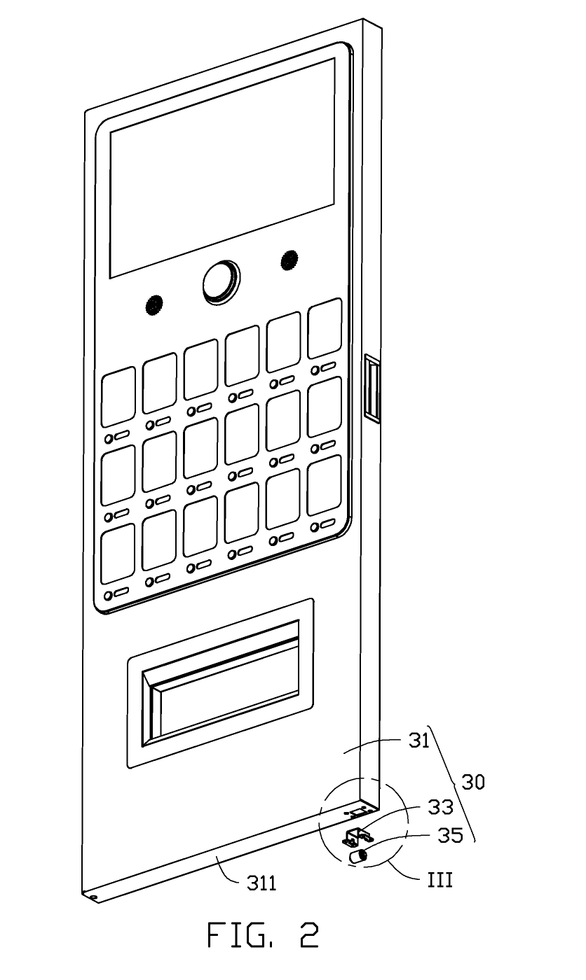

FIG. 3 is an enlarged view of circled portion II of FIG. 2.

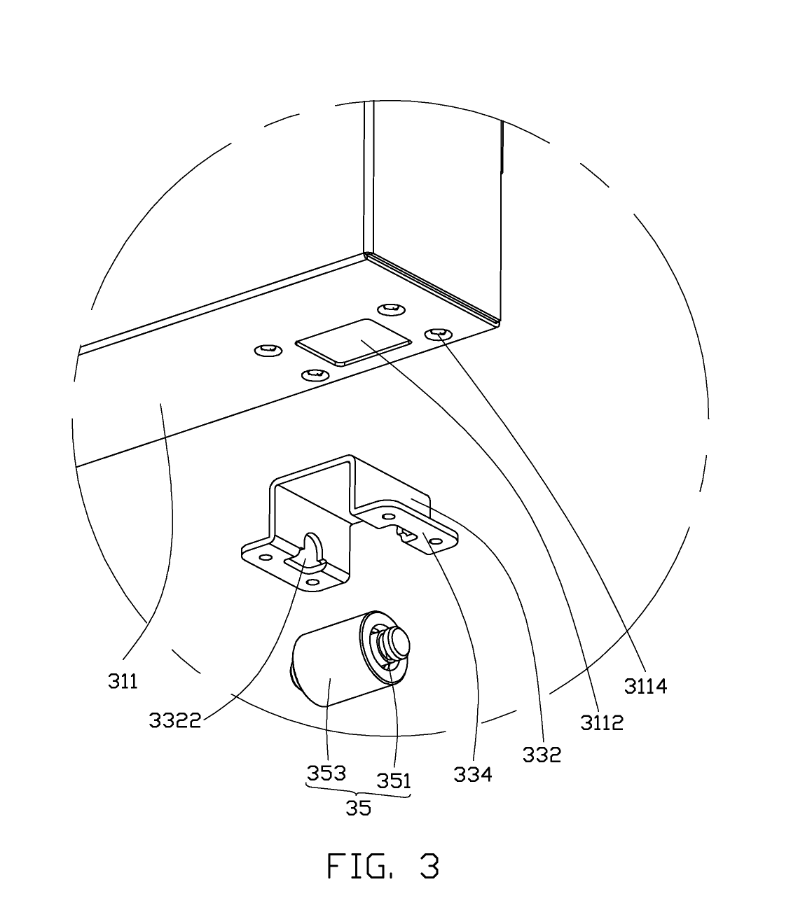

FIG. 4 is an assembled view of the vending machine of FIG. 1.

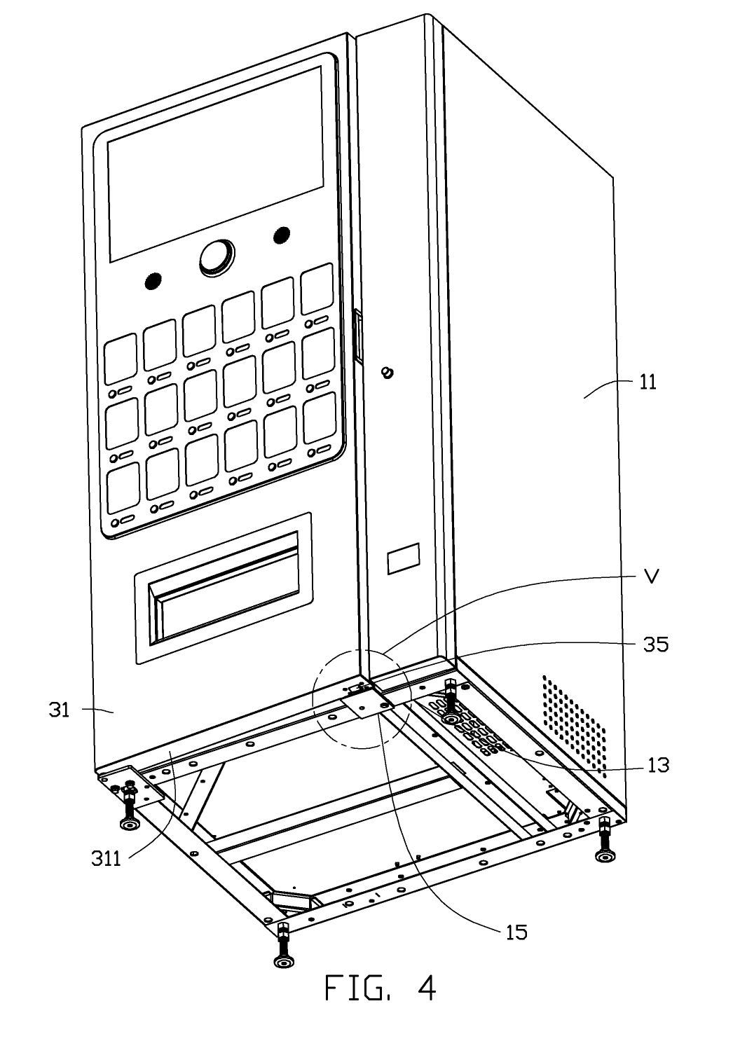

FIG. 5 is an enlarged view of circled portion V of FIG. 4.

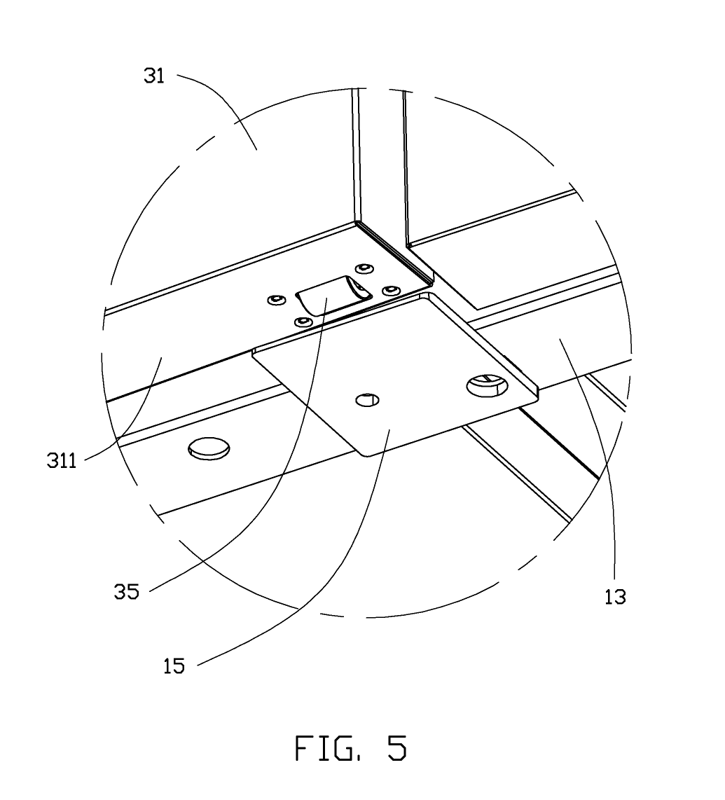

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

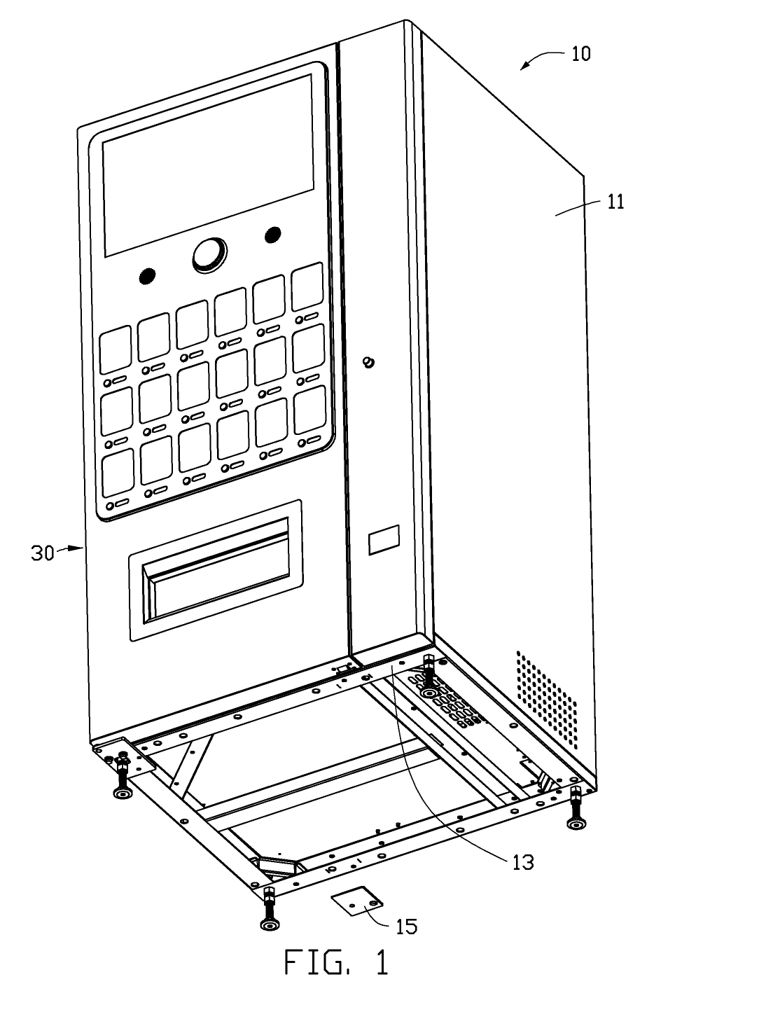

FIG. 1 is an isometric view of a vending machine. The vending machine includes a rack 10 and a door 30 pivotably mounted to the rack 10. The rack 10 includes a side plate 11, a bottom plate 13, and a supporting board 15 mounted to the bottom plate 13. The door 30 is rotatable relative to the rack 10 by a hinge. The supporting board 15 is substantially rectangular and substantially sheet-like.

The door 30 includes a door panel 31, a bracket 33, and a supporting member 35. The door panel 31 includes a bottom surface 311. An opening 3112 and four mounting holes 3114 are defined in the bottom surface 311. The opening 3112 is substantially rectangular. A cross section of the bracket 33 is substantially U-shaped. A receiving space is defined in the bracket 33 to receive the supporting member 35. The bracket 33 includes two substantially parallel mounting walls 332. A mounting board 334 extends from each of the two mounting walls 332. The mounting boards 334 are substantially coplanar and are substantially perpendicular to the two mounting walls 332. A pivot hole 3322 is defined in a junction of each of the two mounting walls 332 and the mounting boards 334. The supporting member 35 includes a pivot shaft 351 and a substantially round supporting portion 353. The supporting portion 353 is rotatable relative to the pivot shaft 351. The supporting portion 353 is resiliently compressed when the supporting portion 353 abuts the supporting board 15. The supporting portion 353 can be made of rubber or plastic, for example.

In assembly, the supporting board 15 is mounted to the bottom plate 13. The supporting member 35 is rotatably mounted to the bracket 33, such that the pivot shaft 351 is received in the pivot holes 3322. The bracket 33 is mounted to the door 30, such that a portion of the supporting portion 353 protrudes out of the bottom surface 311 through the opening 3112. The pivot shaft 351 is substantially parallel to the bottom surface 311.

In use, when the door 30 is closed, the supporting member 35 abuts the supporting board 15. The supporting member 35 partially supports a weight of the door 30 and slows down a rotating speed of the door 30 to prevent the door 30 from hitting the rack 10 when the door 30 is closed.

In another embodiment, the supporting member is spherical.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine, comprising:
a rack comprising a supporting board; and
a door pivotably attached to the rack, the door comprises a door panel, a bracket, and a supporting member, the bracket is located on the door panel, the supporting member is mounted to the bracket, the supporting member protrudes from a bottom surface of the door panel, and the bottom surface is substantially parallel to the supporting board;
wherein when the door is closed relative to the rack, the supporting member abuts the supporting board.

2. The vending machine of claim 1, wherein the supporting member is pivotable relative to the bracket, and the supporting member is a roller.

3. The vending machine of claim 2, wherein the supporting member comprises a pivot shaft and a supporting portion, the supporting portion is rotatable relative to the pivot shaft, and the supporting portion is resiliently compressed when the supporting portion abuts the supporting board.

4. The vending machine of claim 3, wherein the pivot shaft is substantially parallel to the bottom surface.

5. The vending machine of claim 3, wherein the pivot shaft is made of plastic.

6. The vending machine of claim 3, wherein the pivot shaft is located in the door panel, and the supporting portion partially protrudes from the bottom surface.

7. The vending machine of claim 3, wherein the bracket comprises two mounting walls and two mounting boards extend from the two mounting walls, the two mounting walls are parallel to each other, the two mounting boards are fixed to the door panel, and each of the two mounting walls defines a pivot hole for receiving the pivot shaft.

8. The vending machine of claim 7, wherein the two mounting boards are substantially coplanar, and the two mounting boards are substantially perpendicular to the two mounting walls.

9. The vending machine of claim 1, wherein the supporting board is located under the door when the door is closed.

10. A door pivotably attached to a rack of a vending machine, comprising:
a door panel;
a bracket; and
a supporting member, the bracket located on the door panel, the supporting member is mounted to the bracket, the supporting member protrudes from a bottom surface of the door panel;
wherein when the door is closed relative to the rack, the supporting member abuts a supporting board of the rack.

11. The door of claim 10, wherein the supporting member is pivotable relative to the bracket, and the supporting member is a roller.

12. The door of claim 11, wherein the supporting member comprises a pivot shaft and a supporting portion, the supporting portion is rotatable relative to the pivot shaft, and the supporting portion is resiliently compressed when the supporting portion abuts the supporting board.

13. The door of claim 12, wherein the pivot shaft is substantially parallel to the bottom surface.

14. The door of claim 12, wherein the pivot shaft is made of plastic.

15. The door of claim 12, wherein the pivot shaft is located in the door panel, and the supporting portion partially protrudes from the bottom surface.

16. The door of claim 12, wherein the bracket comprises two mounting walls and two mounting boards extend from the two mounting walls, the two mounting walls are parallel to each other, the two mounting boards are fixed to the door panel, and each of the two mounting walls defines a pivot hole for receiving the pivot shaft.

17. The door of claim 16, wherein the two mounting boards are substantially coplanar, and the two mounting boards are substantially perpendicular to the two mounting walls.
